(19) United States
(12) Patent Application Publication
(10) Pub. No.: US 2021/0103884 A1
(43) Pub. Date: Apr. 8, 2021

(54) SYSTEM AND METHOD FOR MAILER SELECTION AND DELIVERY OPTIMIZATION

(71) Applicant: CROWNHILL PACKAGING LTD., Brampton (CA)

(72) Inventors: Ken-Tuin WONG, King City (CA); Olivia PIETERSEN, Brampton (CA); Christopher RIDUNG, Brampton (CA); Marc HYMAN, Toronto (CA); Adam WONG, King City (CA); Rodney TAYLOR, Mississauga (CA); Jason REIBEL, Spring Grove, IL (US)

(21) Appl. No.: 17/021,392

(22) Filed: Sep. 15, 2020

Related U.S. Application Data
(60) Provisional application No. 62/909,866, filed on Oct. 3, 2019.

(51) Int. Cl. G06Q 10/08; G06Q 20/40

(52) U.S. Cl. CPC G06Q 10/0832; G06Q 20/4014; G06Q 10/0836; G06Q 10/0835

(57) ABSTRACT

A method includes: storing (i) a plurality of profiles containing respective receptacle definitions, and (ii) a plurality of mailer definitions containing dimensions for respective mailers; receiving a request containing a profile identifier from a vendor computing device; retrieving the profile corresponding to the profile identifier; and presenting, to the vendor computing device: (i) at least a subset of the mailer definitions and, (ii) for each mailer definition in the subset, respective indications of compatibility between the mailer definition and each of the receptacle definitions contained in the retrieved profile.

### CROSS-REFERENCE TO RELATED APPLICATION

This application claims priority from U.S. provisional patent application No. 62/909,866, filed Oct. 3, 2019, the contents of which is incorporated herein by reference.

### FIELD

The specification relates generally to the packaging and delivery of items, and specifically to a system and method for mailer selection and delivery optimization.

### BACKGROUND

As the volume of e-commerce-driven item shipments to individual consumers and businesses continues to increase, demand for the limited space used to store such items both during the various stages of shipping and at the destination also increases. Failed deliveries, e.g. in which a package is stored at an intermediate facility rather than the final destination, may result from insufficient space being available at the destination to accommodate the package. Such failed deliveries result in additional space being consumed within the transport and logistics chain, reducing space available for subsequent packages. Failed deliveries may also require customers (e.g. the intended recipients of the items) to travel to a pick-up location to retrieve the items. Still further, items that are delivered but cannot be accommodated in a receptacle at the delivery location may be left on the ground, on a porch, or the like, where they are vulnerable to damage or theft.

### SUMMARY

An aspect of the specification provides a method, comprising: storing (i) a plurality of profiles containing respective receptacle definitions, and (ii) a plurality of mailer definitions containing dimensions for respective mailers; receiving a request containing a profile identifier from a vendor computing device; retrieving the profile corresponding to the profile identifier; and presenting, to the vendor computing device: (i) at least a subset of the mailer definitions and, (ii) for each mailer definition in the subset, respective indications of compatibility between the mailer definition and each of the receptacle definitions contained in the retrieved profile.

Another aspect of the specification provides a computing device, comprising: a memory storing (i) a plurality of profiles containing respective receptacle definitions, and (ii) a plurality of mailer definitions containing dimensions for respective mailers; a communications interface; and a processor configured to: receive a request containing a profile identifier from a vendor computing device; retrieve the profile corresponding to the profile identifier; and present, to the vendor computing device: (i) at least a subset of the mailer definitions and, (ii) for each mailer definition in the subset, respective indications of compatibility between the mailer definition and each of the receptacle definitions contained in the retrieved profile.

A further aspect of the specification provides a non-transitory computer-readable medium storing computer-readable instructions executable by a processor of a computing device to: store (i) a plurality of profiles containing respective receptacle definitions, and (ii) a plurality of mailer definitions containing dimensions for respective mailers; receive a request containing a profile identifier from a vendor computing device; retrieve the profile corresponding to the profile identifier; and present, to the vendor computing device: (i) at least a subset of the mailer definitions and, (ii) for each mailer definition in the subset, respective indications of compatibility between the mailer definition and each of the receptacle definitions contained in the retrieved profile.

### BRIEF DESCRIPTIONS OF THE DRAWINGS

Embodiments are described with reference to the following figures, in which:

FIG. 1 depicts a system for mailer selection and delivery optimization.

FIG. 2 depicts certain internal components of the coordination server of the system of FIG. 1.

FIG. 3 depicts a method for mailer selection and delivery optimization.

FIG. 4 depicts an example performance of block 305 of the method 300.

FIG. 5 depicts an example performance of block 315 of the method 300.

### DETAILED DESCRIPTION

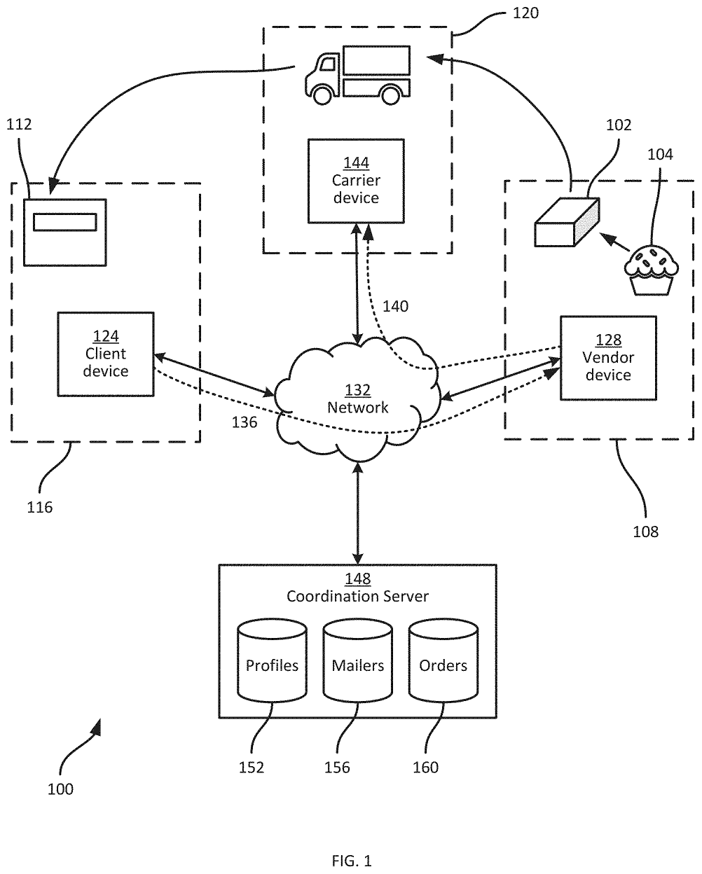

FIG. 1 depicts a system 100 for mailer selection and delivery optimization. The system 100 implements functionality to assist in the selection of a suitable packaging format 102 (also referred to herein as a mailer 102) for an item or set of items 104 to be shipped from a vendor entity 108 to a destination, such as a receptacle 112 at a customer location 116. As will be apparent to those skilled in the art, mailers can encompass a wide variety of packaging materials, including boxes, tubes, envelopes, and the like.

The item 104 contained within the mailer 102 may be transported from physical premises associated with the vendor entity 108 to the customer location 116 via a carrier entity 120, such as a courier or postal service.

Prior to the delivery process summarized above, the item 104 may be purchased from the vendor entity by a customer associated with the customer location 116. For example, a client computing device 124 (e.g. a desktop computer, laptop computer or handheld computing device such as a smartphone) may communicate with a vendor computing device 128 via a network 132 to place an order 136 for the item 104, e.g. via an e-commerce website hosted by or on behalf of the vendor device 128. Following placement of the order, the mailer 102 is selected from a variety of available mailers, the item 104 is packaged within the mailer 102, and the mailer 102 is provided to the carrier entity 120. For example, the vendor computing device 128 may transmit a delivery request 140 to a carrier computing device 144 to coordinate pick-up of the mailer 102 for eventual transport to the customer location 116.

Selection of the mailer 102 at the vendor entity 108 is typically made in the absence of information defining the shape and size of the receptacle 112. Therefore, the shape and size of the mailer 102 may exceed the effective capacity of the receptacle 112, resulting in a failed delivery attempt to the customer location 116. Such failed delivery attempts consume carrier resources (e.g. driver time, fuel, storage space in carrier facilities). In addition, failed delivery attempts may result in the need for a customer to travel to carrier facilities to pick up the mailer 102, consuming further time, fuel and the like.

The effective capacity of the receptacle 112 can be defined by a wide variety of factors. Those factors include physical attributes of the receptacle 112, such as internal dimensions of the receptacle or of an entry point (e.g. a mail slot) to the receptacle 112. The factors defining effective receptacle capacity also include transient factors, such as the presence of other items within the receptacle 112.

In addition to mailer selection typically being made in the absence of information defining the physical attributes of the receptacle 112, delivery to the customer location 116 is typically also made in the absence of such information at the carrier 120. That is, while the carrier entity 120 may generate scheduling and inventory data (e.g. at the carrier computing device 144) to coordinate deliveries from vendors such as the vendor entity 108, the scheduling and inventory data may not contain information defining the effective capacity of the receptacle, which may also be affected by deliveries from other carrier entities.

The absence of receptacle information at the vendor and carrier entities 108 and 120 as set out above may increase the proportion of deliveries that fail and necessitate multiple delivery attempts and/or customer pick-up. Obtaining the above information at the vendor and carrier devices 128 and 144 may require substantial reconfiguration of software executed by those devices. A wide variety of vendor and carrier software is deployed, and the above-mentioned reconfiguration may therefore necessitate many repetitions to equip each vendor and carrier with receptacle information to enable a reduction in failed delivery attempts. Such reconfiguration is time-consuming and costly.

To mitigate failed delivery attempts while also mitigating the cost of the above-mentioned reconfiguration of the vendor and carrier devices 144, the system 100 also includes a coordination server 148 (also simply referred to herein as the server 148). As will be discussed below, the server 148 implements functionality to obtain and store receptacle information from customer entities, and to provide such information, and optionally also scheduling modifications, to the vendor device 128 and the carrier device 144 upon request. As a result, the server 148 may enable a reduction in failed delivery attempts while minimizing deployment costs for such a reduction at the vendor entity 108 and the carrier entity 120.

The server 148 stores various data, shown in FIG. 1 as being divided between a profile repository 152, a mailer repository 156 and an order/transaction repository 160. The repositories 152, 156 and 160 may be combined in a smaller number of repositories in other examples, or subdivided among a larger number of repositories. In brief, the profile repository 152 contains data defining receptacles at customer locations, such as the receptacle 112 at the customer location 116. The mailer repository 156 contains data defining physical characteristics of various mailers (such as the mailer 102). The order repository 160 contains data defining transactions completed between the client device 124 and the vendor device 128, for use by either or both of the vendor device 128 and the carrier device 144.

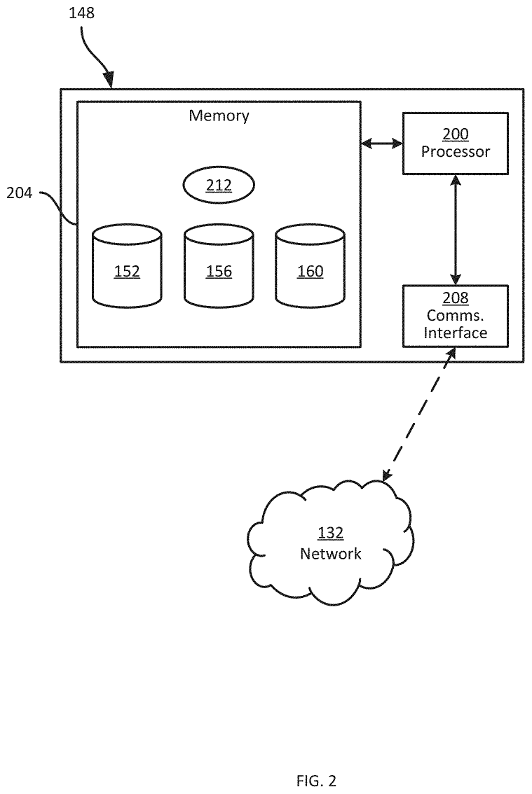

Turning to FIG. 2, certain internal components of the server 148 are shown. In particular, the server 148 includes a special-purpose controller, such as a processor 200, interconnected with a non-transitory computer readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 each comprise one or more integrated circuits. In some examples, the server 148 can be implemented in a distributed manner, e.g. across a plurality of processors and associated memory circuits.

The server 148 also includes a communications interface 208 enabling the server 148 to exchange data with other computing devices, e.g. the client device 124, the vendor device 128 and the carrier device 144, via the network 132. The server 148 can also include input and output assemblies such as a display, keyboard, mouse or the like (not shown).

The memory 204 stores the repositories 152, 156 and 160 mentioned above, as well as computer readable instructions for execution by the processor 200. In particular, the memory 204 stores a coordination application 212 which, when executed by the processor 200, configures the processor 200 to exchange data with at least one of the client device 124, the vendor device 128 and the carrier device 144. The data exchanged via the server 148 may enable the mitigation of failed deliveries resulting from insufficient effective capacity at the receptacle 112 for the mailer 102.

Those skilled in the art will appreciate that the functionality implemented by the processor 200 via the execution of the application 212 may also be implemented by one or more specially designed hardware and firmware components, such as FPGAs, ASICs and the like in other embodiments.

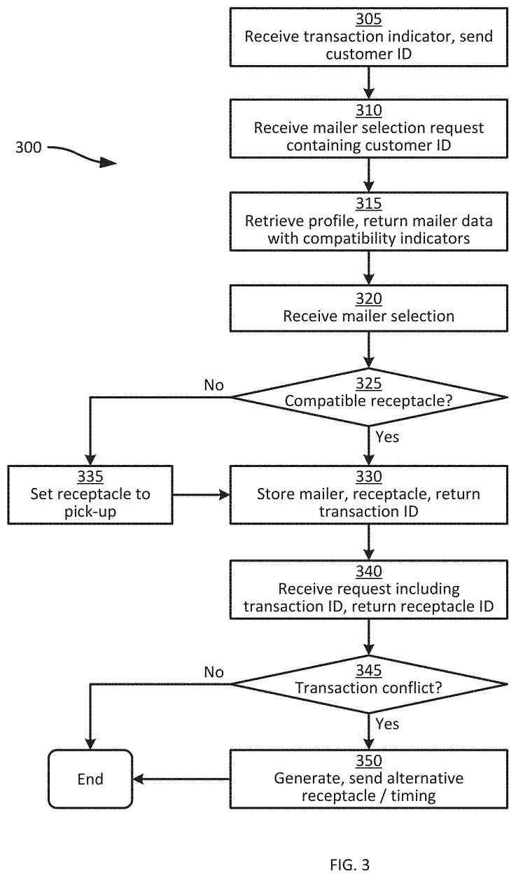

Turning now to FIG. 3, the functionality implemented by the server 148 will be discussed in greater detail. FIG. 3 illustrates a mailer selection and delivery coordination method 300, which will be discussed below in conjunction with its performance within the system 100, and particularly at the server 148.

Prior to performance of the method 300, the server 148 obtains and stores profile data in the repository 152. Each profile record in the repository 152 corresponds to a customer (e.g. the customer location 116) and contains at least one receptacle definition. A receptacle definition contains, for example, an identifier and dimensions for a receptacle at the customer location. Thus, a profile record corresponding to the customer location 116 can contain a receptacle definition containing dimensions for the receptacle 112. An example profile record for the customer location 116 is shown below in Table 1.

TABLE 1
Example Customer Profile

| | | | Receptacle |
|---|---|---|---|
| Customer ID | Receptacle ID | Receptacle Dimensions | Priority |
| 116 | Box-112 | Slot: 3″ H × 12″ W | 1 |
| | | Vol.: 13″ H × 14″ W × 10″ D | |
| | Porch | N/A | 0 |

Data in the repository 152 can be stored in a wide variety of formats other than the tabular format shown above. A similar qualification applies to the example contents of the repositories 156 and 160 discussed herein. In addition, each profile record in the repository 152 can include additional parameters, such as mailing address corresponding to the customer location 116, authentication credentials enabling the client device 124 to access the profile record, and the like.

In the example shown in Table 1, the profile record corresponding to the customer location 116 includes a customer identifier (“116”) that uniquely distinguishes this profile record from other profile records in the repository 156. The profile record also includes two receptacle definitions. Each receptacle definition includes a receptacle identifier (e.g. “Box-112” and “Porch”), as well as receptacle dimensions. The receptacle dimensions can be presented in a variety of forms. For example, the receptacle definition for the receptacle 112 includes two sets of dimensions, for a slot allowing access to a mailbox, and for the mailbox itself. The porch definition, on the other hand, includes a blank dimensions field, indicating that the space available on the porch is effectively unlimited. In other examples, dimensions can also be specified for a porch, including for a door or other entrance to the porch.

The profile record also includes, for each receptacle, a priority level. In the present example, a greater priority level indicates a greater preference for deliveries to be placed in the corresponding receptacle. That is, the mailbox 112 is preferred over the porch, in the example above. In some examples, as will be discussed below in greater detail, a predefined priority level (e.g. the level zero, in this example) indicates that the corresponding receptacle is to be used as a fallback only if additional conditions are met.

Profiles in the repository 152 can be populated by the transmission of data from the client device 124 (and other client devices, not shown) to the server 148 via the network 132. For example, the server 148 can host a website including selectable elements, data fields and the like for receiving data defining the contents of a profile record.

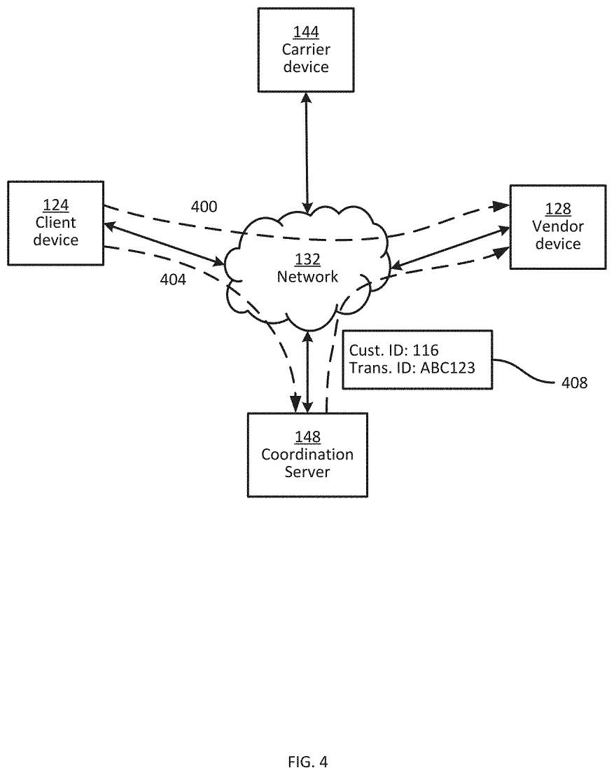

At block 305 of the method 300, the server 148 can receive a transaction indicator. In response to the transaction indicator, the server 148 can transmit at least a customer identifier, and may also transmit a transaction identifier to the vendor device 128. Receipt of the transaction indicator may be implemented using a variety of mechanisms. For example, the client device 124 may access an e-commerce site hosted by or for the vendor device 128, as noted earlier, to complete a transaction (e.g. to purchase the item 104). FIG. 4 illustrates an example request 400 from the client device 124 to the vendor device 128 to complete a checkout process to purchase the item 104.

The e-commerce site can include an element hosted by the coordination server 148 and selectable by the client device 124 to authenticate with the coordination server 148 (e.g. by providing a username and password or the like), e.g. via a message 404 shown in FIG. 4. The coordination server 148 can retrieve the profile record corresponding to the client device 124, and transmit the customer identifier therein to the vendor device 128, via the above-mentioned element embedded in the e-commerce site of the vendor device 128. In some examples, as shown in FIG. 4, the server 148 sends a message 408 including both the customer identifier and a dynamically generated transaction identifier, which is also stored in the profile record corresponding to the client device 124 in the repository 152. The vendor device 128 therefore need only be modified to accept a customer identifier and, when used, the transaction identifier, from the server 148.

Referring again to FIG. 3, at block 310 the server 148 receives a mailer selection request from the vendor device 128, including the above-mentioned customer identifier. In some examples, the request received at block 310 includes the transaction identifier shown in FIG. 4, e.g. previously received in the message 408. In other examples, however, the performance of block 305 can be omitted, and the client device 142 can provide the customer identifier directly to the vendor device 128. In such examples, no transaction identifier is generated at the server 148, and the request received at block 310 therefore includes only the customer identifier.

The request received at block 310 is generated at the vendor device 128 following completion of the above-mentioned transaction. The request can be generated automatically at the vendor device 128 responsive to completion of a transaction. In other examples, the vendor device 128 can generate, responsive to operator input, a plurality of requests to the server 148 for each of a plurality of previously completed transactions. For example, such requests can be generated on a daily basis by the vendor device 128, e.g. when staff at the vendor entity 108 are preparing to package items such as the item 104 for shipping.

In response to receiving the request at block 310, at block 315 the server 148 is configured to retrieve, from the repository 152, the profile corresponding to the customer identifier in the request. The server 148 is also configured to retrieve at least a subset of mailer definitions from the repository 156. Having retrieved the customer profile and mailer definitions, the server 148 is configured to return, to the vendor device 128, the subset of mailer definitions and indications of compatibility between the mailer definitions and the receptacles defined in the customer profile.

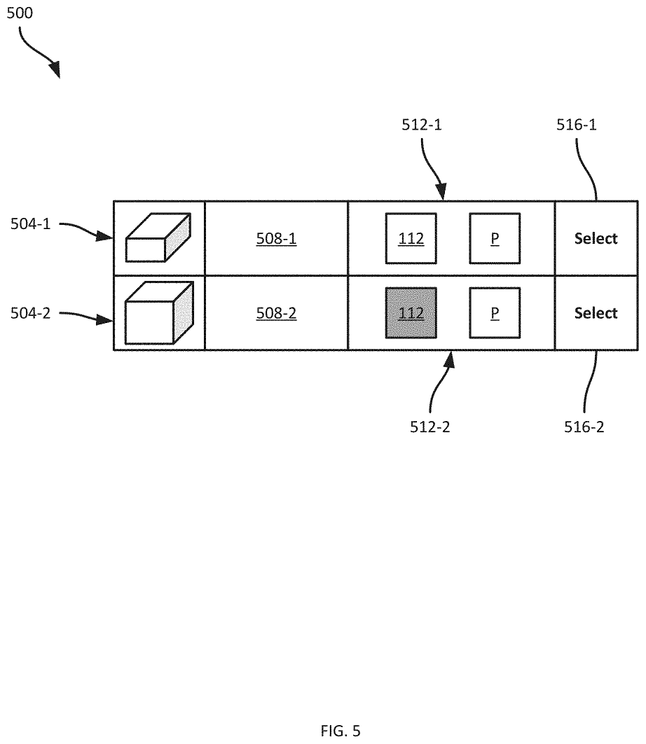

Turning to FIG. 5, an example set of data 500 transmitted from the server 148 to the vendor device 128 at block 315 is illustrated, for example sent as a web page. In particular, the set of data 500 includes two mailer definitions 504-1 and 504-2, including images of the corresponding mailers, as well as dimensions 508 of the mailers. The set of data 500 also includes compatibility indicators 512-1, 512-2 for each mailer definition. The compatibility indicators indicate, e.g. by colour (although a wide variety of other visual indicators of compatibility may also be employed), whether each mailer definition 504 can be physically accommodated by the corresponding receptacle.

In the example of FIG. 5, the compatibility indicators 512-1 for the mailer definition 504-1 indicate that the mailer 504-1 is compatible with both the mailbox and the porch, as defined in the customer profile shown in Table 1. The compatibility indicators 512-2, however, indicate that the mailer definition 504-2 is compatible with the porch, but not with the receptacle 112 (i.e. the mailbox).

Determinations as to compatibility can be made at the server 148 by comparing the dimensions of the mailer definitions and the receptacle definitions. In some examples, the mailer repository 156 includes preconfigured compatibility indicators for each of a plurality of classes of receptacle (e.g. community mailboxes also referred to as cluster boxes, parcel lockers, lobby mailboxes, door slots, concierge desks, and the like). The server 148 can assign each received receptacle definition a class (e.g. upon addition to a customer profile), and the compatibility indicators can therefore be selected for transmission to the vendor device 128 by simply comparing the classes assigned to each receptacle with the classes assigned to each mailer. The compatibility indicators 512 can include icons, text strings or the like indicative of the above classes.

In the present example, the data transmitted at block 315 includes only mailer definitions that are compatible with at least one receptacle in the relevant customer profile. In other examples, a greater subset of mailer definitions can be retrieved and sent to the vendor device 128, up to and including all mailer definitions in the repository 156. In some examples, the subset of mailer definitions transmitted at block 315 can be selected based at least in part on item information received from the vendor device 128 at block 310. For example, rather than sending a customer identifier or transaction identifier that can be used to retrieve a customer profile, the vendor device 128 can also send item information corresponding to the item 104, such as dimensions of the item. The server 148 can then determine which mailer definitions are compatible with the item by comparison of the item dimensions with the mailer dimensions, and present to the vendor device 128 only those mailer definitions.

In some examples, the performance of the method 300 can end at block 315. That is, the server 148 can be configured to provide guidance for mailer selection by indicating which mailers are compatible with the relevant receptacles. In the present example, however, the server 148 implements additional functionality to enable further mitigation of failed delivery attempts.

In particular, the data set 500 sent to the vendor device 128 also includes selectable elements 516-1 and 516-2 enabling selection of the corresponding mailer definition 504, e.g. by activation of an input device (touch screen, mouse or the like) at the vendor device 128. Returning to FIG. 3, at block 320 the server 148 is configured to receive, from the vendor device 128, a mailer selection from the mailer definitions sent at block 315. The selection can be made via activation of one of the elements 516. In other examples, the mailer definitions sent at block 315 can include input elements for generation of a custom mailer definition by the vendor device 128. In such examples, the selected mailer definition received at block 320 may include custom mailer dimensions (i.e, that may not correspond directly to an existing mailer definition in the repository 156).

At block 325, the server 148 is configured to determine whether the selected mailer definition received at block 320 is compatible with any receptacles of the customer profile retrieved at block 315. As noted above, the mailer definitions sent at block 315 may include definitions that are not compatible with the customer's receptacle definitions. The above-mentioned custom mailer definition may also result in a dynamically generated mailer definition that is not compatible with customer receptacles.

The determination at block 325 is performed by comparing the mailer and receptacle definitions and/or classes as noted above. When more than one receptacle from the customer profile is compatible with the selected mailer, the server 148 is configured to select the receptacle identifier having the highest priority level in the customer profile for further use.

As noted earlier, certain receptacle definitions, such as the porch shown in Table 1, have preconfigured priority levels indicating that additional assessments are to be performed at the server 148 before selecting such receptacles for further use. At block 325, therefore, the server 148 can also be configured to determine whether any receptacle definitions in the relevant customer profile include such a preconfigured priority level. In the example shown in Table 1, it is assumed that the priority level “0” is such a preconfigured priority level. The server 148 is therefore configured to assess not only physical compatibility with the selected mailer, but also other factors, Examples of such other factors include weather. For example, the server 148 can retrieve a weather forecast for a predetermined future period (e.g. one week, or a projected delivery window provided by the vendor device 128), and make a negative determination at block 325 if a likelihood of rain in the relevant time period is above a threshold (e.g. 70%). In another example, the server 148 can retrieve reports of package theft (e.g. “porch pirating”) in the vicinity of the customer location 116, and make a negative determination at block 325 for the porch if the number of recent reports is above a threshold.

When the determination at block 325 is affirmative for at least one receptacle, the server 148 proceeds to block 330. At block 330 the server stores a transaction record in the repository 160. The transaction record includes a transaction identifier, which may be generated at block 330 or, when block 305 is implemented, is the transaction identifier from block 305. The transaction record also contains the customer identifier corresponding to the profile retrieved at block 315, as well as an identifier of the selected mailer from block 320 and an identifier of the compatible receptacle selected at block 325.

When the determination at block 325 is negative for each receptacle definition in the customer profile, the server 148 proceeds to block 335 instead of directly to block 330. At block 335, the server 148 selects customer pick up (e.g. at a facility operated by the carrier 120) as the receptacle. In other words, at block 335 the server 148 does not select any receptacle defined in the customer profile. Although in such a scenario a direct delivery to the customer location 116 may not be possible, the wasted resources associated with an attempted delivery to the customer location 116 may still be avoided. Following the performance of block 335, the server 148 proceeds to block 330 as described above, with the receptacle identifier stored in the transaction record being an identifier of the pick-up location rather than a customer receptacle.

Also at block 330, the server 148 is configured to return the above-mentioned transaction identifier to the vendor device 128. The server 128 can also return to the vendor device 128 a label image or the like for applying to the mailer 102, indicating the intended receptacle for delivery (i.e. the receptacle selected at block 325). The receptacle indicator can include an icon similar to the compatibility icons mentioned above. The label image may also include the transaction identifier, e.g. encoded in a barcode or other machine-readable format. As will be apparent in the discussion below, the transaction identifier provided to the vendor device 128 at block 330 enables the carrier device 144 to subsequently retrieve data from the server 148 to mitigate the likelihood of failed delivery attempts.

At block 340, the server 148 is configured to receive a further request, from the carrier device 144, that includes the above-mentioned transaction identifier. The carrier device 144 can obtain the transaction identifier directly from the vendor device 128, e.g. when the vendor device 128 submits a shipment request to the carrier device 144 for the item 104/mailer 102. In other examples, the transaction identifier can be obtained by the carrier device 144 via scanning of the above-mentioned label by a barcode scanner or other data capture device associated with the carrier device 144.

In response to receiving the request at block 330, the server 148 is configured to return the receptacle identifier stored in the transaction record at block 330. The receptacle identifier itself can be returned, or a description of the receptacle (e.g. “front porch” or “mailbox at boulevard”) may be retrieved from the corresponding customer profile. As will now be apparent to those skilled in the art, the receptacle information returned to the carrier device 144 can be employed within the operations of the carrier entity 120 to instruct delivery staff to deposit the mailer 102 in a particular receptacle at the customer location 116. In other examples, where the determination at block 325 was negative and the receptacle identifier contained in the transaction record is a customer pick-up location, the carrier entity 120 can mark the mailer 102 for delivery to a pick-up location rather than to the customer location 116.

The performance of the method 300 can end following the performance of block 340 in some embodiments. In the present embodiment, however, the server 148 implements additional functionality to further mitigate the likelihood of failed delivery attempts.

Specifically, at block 345, the server 148 is configured to determine whether a transaction conflict exists for the customer profile retrieved at block 315. A transaction conflict can occur when a plurality of deliveries are scheduled to arrive at the customer location 116 over a given time period. Although each individual item encompassed by the overlapping deliveries may be compatible with the receptacles at the customer location, the combination of the items to be delivered may exceed the available capacity of the receptacle. The server 148 may therefore periodically (e.g. whenever a new transaction record is created in connection with a given customer profile, and/or at predefined intervals) retrieve all transaction record associated with a given customer profile, and determine whether any conflicts exist.

Assessment of transaction conflicts at block 345 can include determining whether the transactions assigned to a given receptacle include mailers that can be accommodated together within that receptacle. In some examples, the vendor device 128 or the carrier device 144 may have previously provided (e.g. in the request received at block 340) an expected delivery window. In such examples, the determination at block 345 can include the comparison of receptacle attributes with mailer attributes only for those transaction records having overlapping delivery windows.

When the determination at block 345 is negative, the performance of the method 300 ends. When the determination at block 345 is affirmative, however, indicating that a conflict has been detected, the server 148 can be configured to generate alternative delivery data for transmission to the carrier device 144 at block 350.

The generation of alternative delivery data at block 350 can include a repeated performance of block 325, e.g. to determine whether another, lower priority receptacle is compatible with at least one of the incoming mailers. If another compatible receptacle is available, the server 148 can repeat the determination at block 345 for that receptacle. When the other receptacle is compatible and no conflicts are detected, the server 148 can transmit an instruction to the device 144 to associate a transaction with the other receptacle.

In other examples, the generation of alternative delivery data at block 350 can include selecting an updated delivery window and transmitting the updated delivery window to the carrier device 144. The updated delivery window may, for example, be shifted ahead by a day or delayed by a day.

Variations to the above systems and methods are contemplated. For example, in some embodiments the server 148 can assess additional factors at blocks 315 (to select mailers to return to the vendor device 128) and/or block 325 (to assess compatibility of receptacles with a selected mailer) beyond the physical dimensions of the receptacles and mailers. For example, the vendor device 128 can provide additional data to the server 148 indicating a required mailer orientation (e.g. for fragile items), which the server 148 can apply as a constraint to the compatibility determinations.

In further examples, the vendor device 128 can provide target environmental conditions to the server 148 for evaluation at block 325. Examples of such target environmental conditions include temperature, humidity, and the like. For instance, a mailer containing medication, food products or other perishable items may be associated with a permissible temperature range or a maximum permissible temperature. The server 148 may therefore make a negative determination at block 325 for an outdoor (i.e. lacking air conditioning or other cooling) receptacle in hot weather.

In another example, a mailer containing an item such as contact lenses or other fluid-containing items may be associated with a permissible minimum temperature, e.g. to prevent freezing of the fluid in the items. Thus, the server 148 may make a negative determination at block 325 for an outdoor (i.e. unheated) receptacle in cold weather conditions.

To assess environmental conditions such as those mentioned above, the server 148 can make the determination at block 325 based on sensor data associated with the relevant receptacle, weather data retrieved from a third-party computing device for a region encompassing the receptacle, or the like.

In further examples, the customer profile may include indications of customer accessibility requirements and the server 148 can apply such requirements to select the subset of mailers sent at block 315, e.g. prioritizing mailers with easy-open features.

The scope of the claims should not be limited by the embodiments set forth in the above examples, but should be given the broadest interpretation consistent with the description as a whole.

1. A method, comprising:
storing (i) a plurality of profiles containing respective receptacle definitions, and (ii) a plurality of mailer definitions containing dimensions for respective mailers;
receiving a request containing a profile identifier from a vendor computing device;
retrieving the profile corresponding to the profile identifier; and
presenting, to the vendor computing device:
(i) at least a subset of the mailer definitions and,
(ii) for each mailer definition in the subset, respective indications of compatibility between the mailer definition and each of the receptacle definitions contained in the retrieved profile.

2. The method of claim 1, further comprising, prior to receiving the request from the vendor computing device:
receiving an authentication request from a client device via an e-commerce website hosted by the vendor computing device; and
responsive to the authentication request, sending the profile identifier to the vendor computing device.

3. The method of claim 1, wherein the indications of compatibility indicate whether each mailer definition in the subset can be physically accommodated by a given one of the receptacle definitions.

4. The method of claim 3, wherein the indications of compatibility are preconfigured and stored with the mailer definitions.

5. The method of claim 1, further comprising:
receiving a mailer definition selection from the vendor computing device;
determining whether a receptacle definition contained in the retrieved profile is compatible with the received mailer selection;
when no receptacle definition from the retrieved profile is compatible, storing a transaction record associated with the profile and containing an identifier of the selected mailer, and an indication of required pick-up; and
when a receptacle definition from the retrieved profile is compatible, storing a transaction record associated with the profile and containing an identifier of the selected mailer, and an identifier of the compatible receptacle.

6. The method of claim 5, wherein determining whether a receptacle definition contained in the retrieved profile is compatible includes comparing dimensions of the receptacle definition with dimensions associated with the selected mailer definition.

7. The method of claim 5, further comprising: sending a transaction identifier to the vendor computing device.

8. The method of claim 7, further comprising:
receiving a request from a carrier computing device including the transaction identifier;
returning the identifier of the compatible receptacle to the carrier computing device.

9. The method of claim 8, further comprising:
detecting a delivery conflict at the compatible receptacle; and
generating and sending alternative delivery data to the carrier computing device.

10. A computing device, comprising:
a memory storing (i) a plurality of profiles containing respective receptacle definitions, and (ii) a plurality of mailer definitions containing dimensions for respective mailers;
a communications interface; and
a processor configured to:
receive a request containing a profile identifier from a vendor computing device;
retrieve the profile corresponding to the profile identifier; and
present, to the vendor computing device:
(i) at least a subset of the mailer definitions and,
(ii) for each mailer definition in the subset, respective indications of compatibility between the mailer definition and each of the receptacle definitions contained in the retrieved profile.

11. The computing device of claim 10, wherein the processor is further configured, prior to receipt of the request from the vendor computing device, to:
receive an authentication request from a client device via an e-commerce website hosted by the vendor computing device; and
responsive to the authentication request, send the profile identifier to the vendor computing device.

12. The computing device of claim 10, wherein the indications of compatibility indicate whether each mailer definition in the subset can be physically accommodated by a given one of the receptacle definitions.

13. The computing device of claim 12, wherein the indications of compatibility are preconfigured and stored with the mailer definitions.

14. The computing device of claim 10, wherein the processor is further configured to:
receive a mailer definition selection from the vendor computing device;
determine whether a receptacle definition contained in the retrieved profile is compatible with the received mailer selection;
when no receptacle definition from the retrieved profile is compatible, store a transaction record associated with the profile and containing an identifier of the selected mailer, and an indication of required pick-up; and
when a receptacle definition from the retrieved profile is compatible, store a transaction record associated with the profile and containing an identifier of the selected mailer, and an identifier of the compatible receptacle.

15. The computing device of claim 14, wherein the processor is configured, in order to determine whether a receptacle definition contained in the retrieved profile is compatible, to compare dimensions of the receptacle definition with dimensions associated with the selected mailer definition.

16. The computing device of claim 14, wherein the processor is further configured to send a transaction identifier to the vendor computing device.

17. The computing device of claim 16, wherein the processor is further configured to:
receive a request from a carrier computing device including the transaction identifier;
return the identifier of the compatible receptacle to the carrier computing device.

18. The computing device of claim 17, wherein the processor is further configured to:
detect a delivery conflict at the compatible receptacle; and
generate and send alternative delivery data to the carrier computing device.

19. A non-transitory computer-readable medium storing computer-readable instructions executable by a processor of a computing device to:
store (i) a plurality of profiles containing respective receptacle definitions, and (ii) a plurality of mailer definitions containing dimensions for respective mailers;
receive a request containing a profile identifier from a vendor computing device;
retrieve the profile corresponding to the profile identifier; and
present, to the vendor computing device:
(i) at least a subset of the mailer definitions and,
(ii) for each mailer definition in the subset, respective indications of compatibility between the mailer definition and each of the receptacle definitions contained in the retrieved profile.
